(19) United States
(12) Patent Application Publication
(10) Pub. No.: US 2006/0007798 A1
(43) Pub. Date: Jan. 12, 2006

(54) Disk player

(75) Inventor: Yoshinobu Imoto, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/168,382

(22) Filed: Jun. 29, 2005

(30) Foreign Application Priority Data
Jul. 9, 2004 (JP) P2004-203124

(51) Int. Cl. G11B 21/08

(52) U.S. Cl. 369/30.9; 369/47.15

(57) ABSTRACT

In a disk player which plays a disk having first and second areas in which the same contents are recorded with different amounts of information, the disk player includes a playback unit that reads disk information to play the disk, a storage unit that stores disk management information relating to the first and second areas when starting playback of the disk, and a switching instruction unit that, while one area of the first and second areas is played, instructs to play the other area. In response to the switching instruction unit, the disk management information relating to the other area is read from the storage unit, and thus playback of the other area starts.

### BACKGROUND OF THE INVENTION

1. Field of the Invention

The present invention relates to a disk player which plays disks such as CDs, and more specifically, to a disk player which plays disks having a plurality of areas in which the same contents are recorded with different amounts.

2. Description of the Related Art

A disk player for playing a CD has an optical pickup for reading disk information, and demodulates the disk information read by the optical pickup and decodes the demodulated disk information to output the decoded information. Also, as disclosed in Non-patent Document 1, a super audio CD (registered trademark) using a DSD (Direct Stream Digital) method different from a conventional PCM method as a recording method of audio data has been standardized. Therefore, Hybrid CDs having an area in which the same music is recorded using the PCM method and an area in which the same music is recorded using the DSD method in order to be capable of being played in conventional disk players have been commercialized.

Further, disk players, which can play super audio CDs, are configured to be capable of playing CDs in which data is recorded using the conventional PCM method. Therefore, at the time of viewing and listening to a hybrid CD, it is possible to perform switching between an area recorded in the PCM method and an area recorded in the DSD method.

In JP-A-2002-170330 (refer to pages 2 to 7 and FIG. 1), a disk player playing a CD having an area in which audio data is recorded in a PCM method and an area in which the audio data is recorded in a DTS (Digital Theater System) method is disclosed. According to the disk player, when areas are switched, it is possible to start playback within a short time by detecting a synchronizing signal and a header. Please also refer Sony Corporation, “SUPER AUDIO CD”, [online], Sep. 13, 2003, Sony Corporation, [search date: Jun. 30, 2004], Internet <URL:http:/www.super-audiocd.com/aboutsacd/format.html>

### SUMMARY OF THE INVENTION

However, according to the disk player disclosed in JP-A-2002-170330 (refer to pages 2 to 7 and FIG. 1), at the time of switching areas, TOC (Table Of Contents) information including the number of songs and a playing time recorded in each area is read. For this reason, it is not possible to switch areas quickly, making usability worse when users use the disk player.

It is an object of the invention to provide a disk player capable of improving usability by quick area switching.

According to one aspect of the invention, there is provided a disk player which plays a hybrid disk, in which a super audio CD layer, having a two-channel stereo area and a multi-channel area, and a CD layer, having a CD area, are laminated and in which the same contents are recorded in the two-channel stereo area, the multi-channel area and the CD area with different amounts of information, the disk player including: a playback unit that reads disk information to play the disk; a storage unit that stores TOC information relating to the two-channel stereo area, the multi-channel area, and the CD area when starting playback of the disk; a switching instruction unit that, while one area of the two-channel stereo area, the multi-channel area and the CD area is played, instructs to play the other area; and a searching unit that searches a predetermined location within contents. Here, in response to the switching instruction unit, the TOC information relating to the other area is read from the storage unit, a playback location within contents at the time when there is an instruction of the switching instruction unit is stored in the storage unit, and the same location within the contents of the switched area is searched by the searching unit, and thus playback of the other area starts.

According to the above configuration, when a hybrid disk is inserted, the TOC information relating to the two-channel stereo area, the multi-channel area, and the CD area is stored in the storage unit. The disk player plays, for example, a designated area based on the TOC information. When the switching instruction unit issues, for example, an instruction to switch over to the multi-channel area, the playback location of the CD area being played is stored in the storage unit and the TOC information relating to the multi-channel area is read from the storage unit. Next, a location at the time of switching is read from the storage unit and the searching unit searches the same location of the multi-channel area as the location based on the TOC information relating to the multi-channel area. Then, the multi-channel area is played.

Further, according to another aspect of the invention, there is provided a disk player which plays a disk having first and second areas in which the same contents are recorded with different amounts of information, the disk player including: a playback unit that reads disk information to play the disk; a storage unit that stores disk management information relating to the first and second areas when starting playback of the disk; and a switching instruction unit that, while one area of the first and second areas is played, instructs to play the other area. Here, in response to the switching instruction unit, the disk management information relating to the other area is read from the storage unit, and thus playback of the other area starts.

According to the above configuration, when a disk is inserted, the disk management information relating to the first and second areas is stored in the storage unit. The disk player plays, for example, the first designated area based on the disk management information. When the switching instruction unit issues an instruction to switch over to the second area, the disk management information relating to the second area is read from the storage unit. Then, the second area is played based on the disk management information relating to the second area. The disk management information has information relating to recording locations of data files, and information relating to the number of songs or a playing time, etc.

Furthermore, in the disk player having the above-mentioned configuration, it is preferable that the disk player further include a searching unit that searches a predetermined location within contents, and a playback location within contents at the time when there is an instruction of the switching instruction unit is stored in the storage unit, and the same location within the contents of the other area switched by the switching instruction unit is searched by the searching unit, and thus playback of the other area start.

According to the above configuration, for example, when the switching instruction unit issues an instruction to switch over to the second area during playback of the first area, the playback location of the first area being played is stored in the storage unit and the disk management information relating to the second area is read from the storage unit. Next, a location at the time of switching is read and the searching unit searches the same location of the second area as the location based on the disk management information relating to the second area. Then, the second area is played.

In addition, in the disk player having the above-mentioned configuration, it is preferable that the first and second areas be recorded in first and second layers laminated in the disk, respectively.

Moreover, in the disk player having the above-mentioned configuration, it is preferable that the first and second areas be recorded with the same layer of the disk divided.

According to the above-aspects of the invention, the TOC information relating to the two channel stereo, the multi-channel, and the CD area is stored at the time of the disk playback, and the same location within the contents of the switched area is searched by the searching unit, and thus playback of the switched area starts. Accordingly, it is possible to quickly switch respective areas of a hybrid disk having a super audio CD layer and a CD layer and to start playback from the same location within the contents at the time of the area switching. Thereby, usability of the disk player can be improved.

Further, according to the above-aspects of the invention, since the disk management information relating to the first and second areas is stored and the disk management information relating to the switched area is read from the storage unit, it is possible to quickly switch between respective areas and to play the respective areas. Thereby, the usability of the disk player can be improved.

Furthermore, according to the above-aspects of the invention, the playback location within the contents of the area before switching is stored, and the same location of the switched area as the playback location is searched by the searching unit, and thus the playback of the switched area starts. Thereby, it is possible to play from the same location of the contents at the time of switching the area.

### BRIEF DESCRIPTION OF THE DRAWINGS

These and other objects and advantages of this invention will become more fully apparent from the following detailed description taken with the accompanying drawings in which:

FIG. 1 is a block diagram showing a configuration of a disk player according to an embodiment of the invention; and

FIG. 2 is a flowchart illustrating operation of the disk player according to the embodiment of the invention.

### DESCRIPTION OF THE PREFERRED EMBODIMENTS

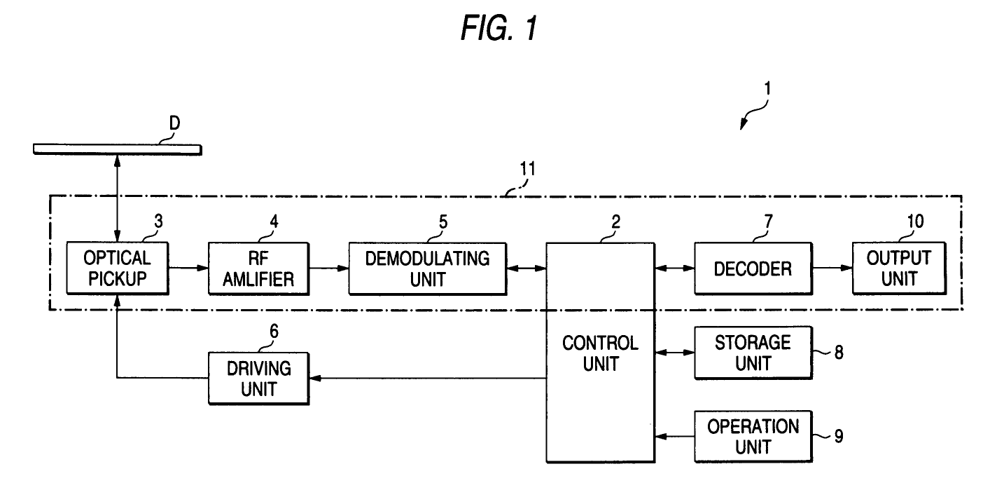

Hereinafter, an embodiment according to the present embodiment will be described with reference to the drawings. FIG. 1 is a block diagram showing a configuration of a disk player according to an embodiment. The disk player 1 has a control unit 2 for controlling respective units. The control unit 2 is connected to a demodulating unit 5, a driving unit 6, a decoder 7, a storage unit 8, and an operation unit 9.

The driving unit 6 drives an optical pickup 3 for reading information recorded in a disk D. The optical pickup 3 is connected to an RF amplifier 4, which is connected to the demodulating unit 5. The RF amplifier 4 amplifies a high-frequency signal detected by the optical pickup 3. The demodulating unit 5 demodulates audio data from the signal amplified by the RF amplifier 4.

The decoder 7 connected to the control unit 2 decodes the audio data demodulated by the demodulating unit 5. The decoded audio data is outputted through an output unit 10 connected to the decoder 7. Accordingly, the optical pickup 3, the RF amplifier 4, the demodulating unit 5, the control unit 2, the decoder 7 and the output unit 10 constitutes a playback unit 11 which plays audio data recorded in a disk.

The storage unit 8 connected to the control unit 2 is composed of an EEPROM or a RAM, and temporarily stores, for example, an operation result of the control unit 2. The operation unit 9 is provided in the main body of the disk player 1 or a remote controller (not shown) capable of communicating with the main body, and users can issue various instructions to the control unit 2 by operating the operation unit.

The playback unit 11 is configured to be able to play a super audio CD recorded in a DSD method as well as a CD recorded in a PCM method. Further, the playback unit 11 is configured to be able to play tracks recorded in the super audio CD, that is, tracks recorded for multi-channel as well as tracks for two-channel stereo.

Therefore, the disk player can play a single-layer disk such as a super audio CD having a two-channel stereo area and a multi-channel area in a single record layer. Further, the disk player can play a double-layer disk such as a super audio CD in which a layer composed of a two-channel stereo area and a layer composed of a multi-channel area are laminated. Furthermore, the disk player can play a hybrid disk in which a CD layer having a CD area and a super audio CD layer having a two-channel stereo area and a multi-channel area are laminated.

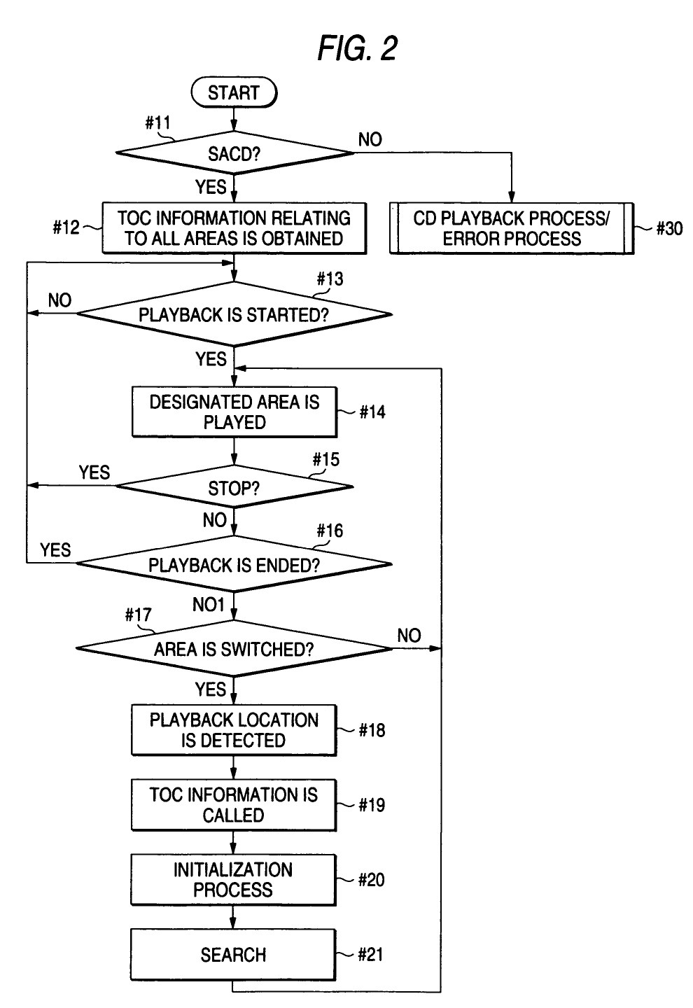

FIG. 2 is a flowchart illustrating operation of the disk player 1. When the disk D is inserted into the disk player 1, it is determined whether or not the disk D is a super audio CD such as a hybrid disk at step 11. In a case when the disk D is not a super audio CD, the process proceeds to step 30. In step 30, when the disk D is a common CD, a CD playback process is carried out. When the disk D is not a common CD, since the disk cannot be played, an error process is carried out.

In a case when the disk D is a super audio CD, TOC information relating to entire areas is read and stored in the storage unit 8. At this time, in a case when the disk D is a single-layer disk or a double-layer disk, TOC information relating to the two-channel stereo area and the multi-channel area is read. In a case when the disk D is a hybrid disk, TOC information relating to the two-channel stereo area, the multi-channel area, and the CD area is read.

In step 13, the disk player 1 stands by until an area to be played is designated by operation of the operation unit 9. When an area to be played is designated, the process proceeds to step 14. In step 14, contents of the designated area are played by the playback unit 11 based on the TOC information. In step 15, it is determined whether or not there is an instruction to stop the playback by operation of the operation unit 9. When there is instruction to stop the playback, the playback by the playback unit 11 is stopped. Then, the process returns back to the step 13 and the disk player waits for an instruction to start playback.

When there is no instruction to stop the playback, the process proceeds to step 16. In step 16, it is determined whether or not the playback for the contents of the designated area has ended. In a case when the playback has ended, the process returns back to the step 13 and the disk player waits for an instruction to start playback. In a case when the contents are being played, the process proceeds to step 17. In step 17, it is determined whether or not there is an instruction to switch over to and play another area by operation of the operation unit 9.

When there is no instruction to switch over to another area, the process returns back to step 14 to continue the playback and steps 14 to 17 are repeated. When there is an instruction to switch over to another area by the operation unit 9, the process proceeds to step 18. Further, there is provided a switching instruction unit that issues an instruction to switch over to and play another area by the operation unit 9.

In step 18, the playback location of the contents being played when the instruction to switch areas has been issued is detected by the control unit 2 and is stored in the storage unit 8. In step 19, the TOC information relating to the area to be switched is called from the storage unit 2. In step 20, the decoder 7 is initialized based on the TOC information.

In step 21, location information relating to the playback location stored in the storage unit 8 is read, and the optical pickup 3 is moved by the driving unit 6 based on the location information and the TOC information. Next, the playback unit 11 searches the switched area while reading the signal from the disk so as to detect the same location as that of the contents. As a result, the driving unit 6 and the playback unit 11 constitute a searching unit for searching a predetermined location within the contents.

When the searching unit detects the same location as that of the contents, the process returns back to step 14. In step 14, the playback unit 11 plays the switched area. At this time, the playback starts from the same location as that of the contents when instructed to switch areas. Next, when the playback ends, the process returns back to the step 13 based on the determination in the step 16.

According to the embodiment, in a case in which the disk D is a hybrid disk, the TOC information relating to the two-channel stereo area, the multi-channel area, and the CD area is stored in the storage unit, at the time of starting the playback of the disk. In a case in which the disk D is a single-layer disk or a double-layer disk, the TOC information relating to the two-channel stereo area and the multi-channel area is stored in the storage unit, at the time of starting the playback of the disk. At the time of switching areas, the TOC information is read from the storage unit and then the playback is performed. Accordingly, it is possible to quickly switch between areas. In this way, usability of the disk player 1 can be improved.

In addition, since the playback starts after the playback location within the contents before switching areas is stored and the same location of the switched area as the playback location is searched by the searching unit, it is possible to continue the playback from the same location as that of the contents at the time of switching areas. Therefore, difference in sound qualities due to different recording methods can be compared while listening, and thus usability of the disk player 1 can be further improved.

In addition, in the embodiment, the disk player plays the disk D composed of a super audio CD. However, it is possible to employ a disk player which plays a disk in which the same contents are recorded in the first area and the second area with different amounts of information. At this time, the TOC information is not recorded in a disk such as a DVD, whereas disk management information (for example, information relating to the number of songs or a playing time), which includes information relating to recording locations of data files and manages the disk, is read when starting playback of the disk and stored in the storage unit 8. Thereby, the same effect can be obtained.

### INDUSTRIAL APPLICABILITY

The above-mentioned embodiments of the invention can be applied to disk players which play disk media such as CDs or DVDs.

What is claimed is:

1. A disk player which plays a hybrid disk, in which a super audio CD layer having a two-channel stereo area and a multi-channel area, and a CD layer having a CD area are laminated and in which the same contents are recorded in the two-channel stereo area, the multi-channel area and the CD area with different amounts of information, the disk player comprising:
a playback unit that reads disk information to play the disk;
a storage unit that stores TOC information relating to the two-channel stereo area, the multi-channel area, and the CD area when starting playback of the disk;
a switching instruction unit that, while one area of the two-channel stereo area, the multi-channel area and the CD area is played, instructs to play the other area; and
a searching unit that searches a predetermined location within contents,
wherein the TOC information relating to the other area is read from the storage unit in response to the switching instruction unit,
a playback location within contents at the time when there is an instruction of the switching instruction unit is stored in the storage unit, and
the same location within the contents of the switched area is searched by the searching unit to start a playback of the other area.

2. A disk player which plays a disk having first and second areas in which the same contents are recorded with different amounts of information, the disk player comprising:
a playback unit that reads disk information to play the disk;
a storage unit that stores disk management information relating to the first and second areas when starting playback of the disk; and
a switching instruction unit that, while one area of the first and second areas is played, instructs to play the other area,
wherein the disk management information relating to the other area is read from the storage unit in response to the switching instruction unit to start a playback of the other area.

3. The disk player according to claim 2, further comprising:
a searching unit that searches a predetermined location within contents,
wherein a playback location within contents at the time when there is an instruction of the switching instruction unit is stored in the storage unit, and
wherein the same location within the contents of the other area switched by the switching instruction unit is searched by the searching unit to start a playback of the other area.

4. The disk player according to claim 2, wherein the first and second areas are recorded in first and second layers laminated in the disk, respectively.

5. The disk player according to claim 2, wherein the first and second areas are recorded in the same layer of the disk with the layer divided.
